(19) United States
(12) Patent Application Publication
(10) Pub. No.: US 2021/0049674 A1
(43) Pub. Date: Feb. 18, 2021

(54) PREDICTIVE SELECTION OF PRODUCT VARIATIONS

(71) Applicant: eBay Inc., San Jose, CA (US)

(72) Inventors: Ramesh PERIYATHAMBI, San Ramon, CA (US); Manojkumar Rangasamy KANNADASAN, Fremont, CA (US); Lakshimi DURAIVENKATESH, San Ramon, CA (US); Tomer LANCEWICKI, Jersey City, NJ (US); Selcuk KOPRU, San Jose, CA (US)

(21) Appl. No.: 16/543,500

(22) Filed: Aug. 16, 2019

(51) Int. Cl. G06Q 30/06; G06F 9/451; G06F 16/955; G06N 20/00

(52) U.S. Cl. CPC G06Q 30/0643; G06N 20/00; G06F 16/955; G06F 9/451

(57) ABSTRACT

The disclosed technologies include receiving a selection of an item, where the item has a plurality of selectable configurations. Feature data that is associated with the item is accessed. The feature data includes product information and a purchase history for the plurality of selectable configurations for the item. Based on the feature data, one or more of the selectable configurations are predicted to be of interest to a user associated with the selection. A user interface including the predicted configurations with the feature data is rendered.

### BACKGROUND

A product or service is typically identified by a stock keeping unit (SKU) identifier. An SKU may be associated with any item that is sold and otherwise tracked for inventory purposes. The SKU may uniquely identify an item with particular attributes associated with the item that distinguish the item from other items. Such attributes may include manufacturer, description, material, size, and color.

Many items that are presented on user interfaces such as product websites rendered on a web browser or products rendered via an application are available in more than one configuration. Such items may be referred to as multi-SKU (MSKU) items that have a number of selectable variations that must be selected by the user. For example, a product displayed on a web page may require the user to select a number of configuration options using dropdown menus. Users must select these values (e.g., color, size, model) in order to purchase that item. The user must also select each of the variations in order to be shown the price for a particular variation and its availability.

It is with respect to these and other technical considerations that the disclosure made herein is presented.

### SUMMARY

The effort and delay required to navigate through configurable selections as described above may have a number of detrimental effects. For example, requiring the selection of numerous choices in order to view an item price may cause user to lose interest in purchasing the item. Additionally, providing too many choices may overwhelm some users and deter the users from finalizing a purchase. From a resource standpoint, processing numerous combinations of features may unnecessarily consume computing, storage, and network resources. The present disclosure provides a way to automatically select the most likely variations for a user and present the selected variations to the user. The variations may be predicted based on a number of factors and the variations may further be selected to optimize one or more objectives. For example, variations may be selected that are predicted to maximize the likelihood that the user will choose one of the selected variations for purchase. In some embodiments, the factors may include personalized factors that are specific to a particular user.

In some embodiments, a personalized set of recommended product variations may be determined using a machine learning model. In one example, the machine learning model can be based on features such as percentage sold (whether a particular variation has a high sell rate which can generate interest), percentage discounts (whether a particular variation is associated with a higher discount which may generate user interest), number of clicks (whether a particular variation has received a higher number of clicks by other users), and past user behavior (whether a user would be interested in a particular set of variations based on previous clicks, add to cart actions, past purchases). The machine learning model may be configured to predict likely variations of interest. In some embodiments, the number of recommended variations may be determined based on current display capabilities of the device that is rendering the product information. In some embodiments, reinforcement learning may be utilized to implement feedback and reward to reinforce desired objectives.

The disclosed technologies address the technical problems presented above, and potentially others, by intelligently selecting a likely set of variations and simplifying user interfaces, thus providing users with more relevant information that may increase their level of interest and participation in a given purchase process. The disclosed technologies also allow for reduction of the amount of unnecessary user selections, thus reducing the waste of computing resources (e.g., amount of memory or number of processor cycles required to maintain all combinations of configurations) and network bandwidth (because numerous user requests may require network use). Other technical benefits not specifically mentioned herein can also be realized through implementations of the disclosed technologies.

It should be appreciated that the subject matter described above and in further detail below can be implemented as a computer-controlled apparatus, a computer-implemented method, a computing device, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying FIGS. In the FIGS., the left-most digit(s) of a reference number identifies the FIG. in which the reference number first appears. The same reference numbers in different FIGS. indicate similar or identical items.

FIG. 1 is a system diagram illustrating one embodiment disclosed herein;

FIG. 2 is a diagram showing aspects of an example system according to one embodiment disclosed herein;

FIG. 3 is a diagram showing an example user interface according to one embodiment disclosed herein;

FIG. 4 is a block diagram illustrating an example system as disclosed herein;

FIG. 5 is a flow diagram showing aspects of an illustrative routine, according to one embodiment disclosed herein;

FIG. 6 is a flow diagram showing aspects of an illustrative routine, according to one embodiment disclosed herein;

FIG. 7 is a computer architecture diagram illustrating aspects of an example computer architecture for a computer capable of executing the software components described herein.

FIG. 8 is a data architecture diagram showing an illustrative example of a computer environment.

### DETAILED DESCRIPTION

In various embodiments, the following Detailed Description presents technologies for generating personalized recommendations and selections of product variations on a product page for a given user based on a machine learning model. It is to be appreciated that while the technologies disclosed herein are primarily described in the context of online systems, the technologies described herein can be utilized to generate recommendations and selections of variations in other contexts, which will be apparent to those of skill in the art.

Many items that are available for online purchase are multi-SKU (MSKU) items with one or more selectable variations. In some examples, the variations are selectable via dropdown menus or radio buttons. Users are typically required to select the available options in order to p (EB-00036US) determine if inventory is available and what the price will be, which are all required in order to continue purchasing the item. The disclosed embodiments may thus improve the user experience while facilitating the purchase of items by providing personalized top desired variations. In some embodiments, the variations may be rendered with corresponding indicators signals such as percentage sold or percentage discounts. Based on item information and past user behavior, a machine learning model may be implemented that is configured to predict and present variations that are most likely to be of interest to the user. In some embodiments, reinforcement learning techniques may be implemented to reward the learning process based on the observed data.

In one embodiment, the machine learning model can be based on one or more of the following features:

Variation Sold

This property may be associated with the number of items of a particular variation that has been sold, which may indicate a level of interest by users in general. In some cases, the number of items sold may be further segmented by number of items sold within a specified time period, or the number of items sold within a specific region or demographic category. A high number of items sold may indicate a general likelihood that the user may prefer the variation.

Variation Discount

This property may be associated whether a particular variation has an associated discount which may generate interest in some users. In some cases, certain variations may be associated with higher discounts than other variations. A high discount associated with a given variation may indicate a higher likelihood that the user may prefer the variation.

Variation Clicks

This property may be associated with the number of mouse clicks or other indications that a particular variation has seen a level of interest by other users. In some cases, the number of clicks may be further segmented by number of clicks within a specified time period, or number of clocks within a specific region or demographic category. A high number of clicks may indicate a general likelihood that the user may prefer the variation.

User Interests

This property may be associated with data which may indicate whether a user would be interested in a particular variation or a set of variations based on known user preferences, such as preferences identified in a user account. Product variations with a higher correlation with user interests and preferences may indicate a higher likelihood that the user may prefer the variation

Past user behavior

This property may be associated with record of past user behavior such as mouse clicks, items previously purchased or added to cart, and items subscribed to or watched. This data may be analyzed to infer a pattern of preferences that may indicate a correlation to certain product variations.

Based on the available data, the machine learning model may predict the top product variations for the user. The top variations may be preselected and rendered on the product page. In some embodiments, after a predetermined time, the subsequent user actions may be determined to provide feedback to the machine learning model and whether the selected product variations increased the likelihood of a desired objective. The objective can include, for example, increased sales of the item, or increased time that the user spends on the product site. The resulting user action may be fed back to the machine learning model to further update the model.

Referring to the appended drawings, in which like numerals represent like elements throughout the several FIGURES, aspects of various technologies for test conduct and monitoring will be described. In the following detailed description, references are made to the accompanying drawings that form a part hereof, and which are shown by way of illustration specific configurations or examples.

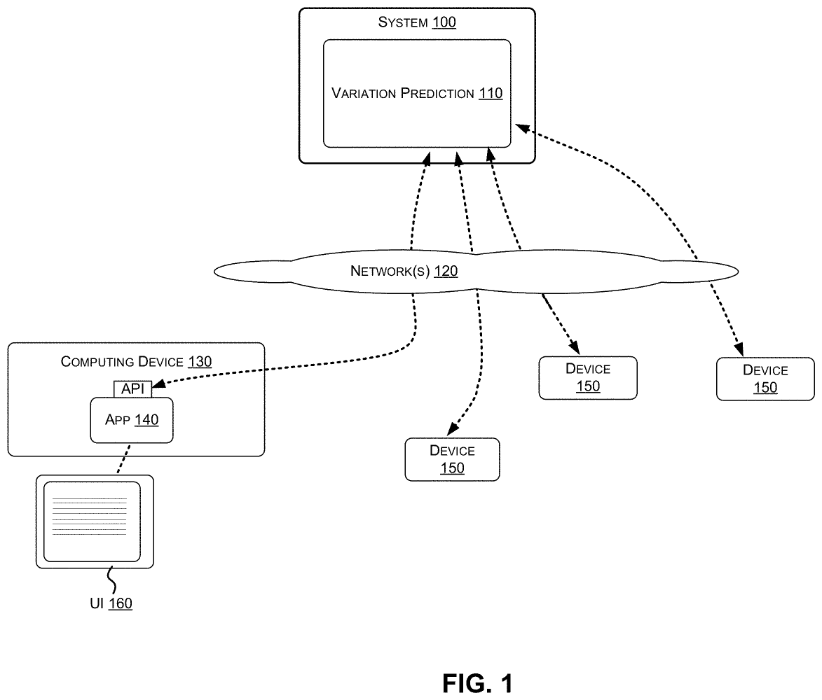

In the example system illustrated in FIG. 1, a system 100 is illustrated that implements variation prediction function 110. The variation prediction function 110 may be configured to provide product information to various devices 150 over a network 120, as well as computing device 130. A user interface 160 may be rendered on computing device 130. The user interface 160 may be provided in conjunction with an application 140 that communicates to the variation prediction function 110 using an API via network 120. In some embodiments, system 100 may be configured to provide product information to users. In one example, variation prediction function 110 may be configured to predict and present the top selling or desired variations to computing device 130 and various devices 150.

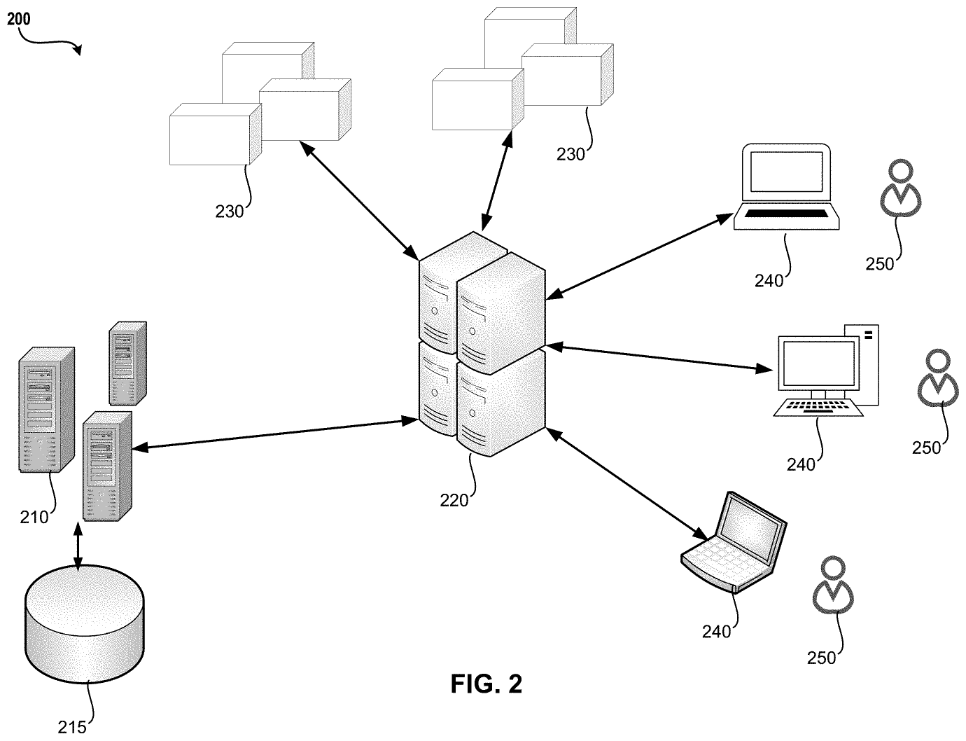

FIG. 2 illustrates a block diagram showing an example variation prediction environment. FIG. 2 illustrates a test variation prediction environment 200 that may include servers 210. The servers 210 may comprise one or more servers, which may collectively referred to as “server.” The variation prediction environment 200 may further include a database 215, which may be configured to store various information used by the server 210 including product data, user data, and the like. The variation prediction environment 200 may further include communications server 220, which, for example, enables network communication between the server 210, online servers 230, and client devices 240. The client devices 240 may be any type of computing device that may be used by users 250 to connect with the server 210 over a communications network. Users 250 may be, for example, users who are accessing services provided by communications server 220 and/or online servers 230. The servers 230 may be operated by any party that is involved in providing, for example, online services. For example, the servers 230 may be configured to implement auction sites or online transactions. Accordingly, the servers 230 may be any type of computing device described herein as may be operated by an auction broker, a financial institution, and the like. The servers and devices represented in FIG. 2 communicate via various network communications hardware and software to facilitate the collection and exchange of data for use in a networked environment.

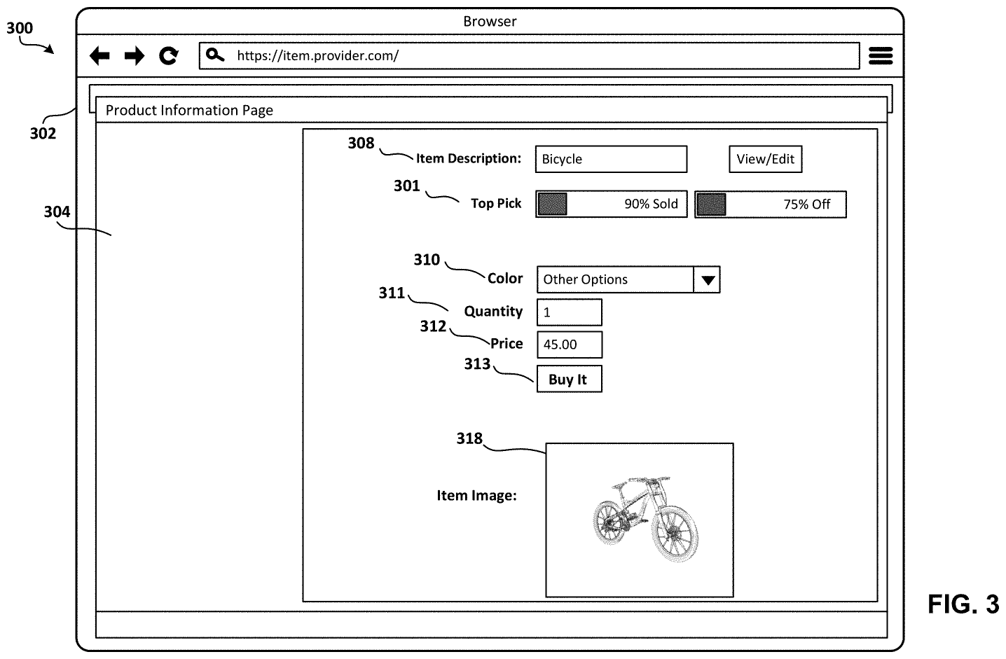

FIG. 3 illustrates one example of a display 300 that may be used to provide product information to a user in accordance with the present disclosure. The display 300 may render a browser window 302 that may render a product information page 304. The product information page 304 may include information pertaining to a particular item that is available for purchase. The product information page 304 may include information such as the item description 308, item image 318, quantity 311, price 312, and an interactive control 313. The product information page 304 may further provide top selected variations for color 301. The top selected variations 301 may be determined by a machine learning model based on feature data associated with the item. The feature data may include product information and a purchase history for the item. The product page 304 may further provide an option 310 to select other variations if the user does not want any of the top variations 301.

In various embodiments, a prediction may be determined as to selectable variations to present to the user. In an example scenario, a centralized database may store feature data associated with the item. The feature data including product information and a purchase history for a given item. The product information may include a number of sales for each of the selectable configurations, discounts associated with the selectable configurations, and numbers of user clicks for the selectable configurations. The database may also include historical data associated with the user. The historical data may include previous clicks, add to cart actions, and past purchases.

A query function may be used to query the database for the latest information. Based on the latest information, one or more top variations or configurations may be selected for presentation to users who are viewing the product information, for example on their web browser. If the user is required to select all of the product variations, then the user may view every combination of configurations, resulting in inefficient utilization of network and computing resources. If the selection process is cumbersome, then the user may not wish to continue with the purchase process, which can lead to user dissatisfaction and possible loss of user participation and sales. If the prediction for the product variations provides timely and desirable selections, user satisfaction in the sales process may be enhanced. In some cases, product sales may be increased based on the top product variations being provided in a timely and efficient manner.

In one embodiment, a machine learning model may be implemented to determine top product variations. The machine learning model may enable determination of likely selections that are based on one or more factors. The factors may be associated with product history, such as number of sales for each of the selectable configurations, discounts associated with the selectable configurations, and numbers of user clicks for the selectable configurations. The factors may also be associated with the item such as price of the item, the type of the item, and the number of users who are interested in the item. The factors may also be associated with the user, such as the purchase history of the user and other information that are unique for the user.

As used in this disclosure, the product variations may correspond to different SKUs, and may relate to color, size, model, and other features. The product variations may generally be referred to as configurations or SKUs.

In an embodiment, a top variation machine learning model may be implemented with a feedback loop to update the predictions based on currently available data. In some configurations, the top variation machine learning model may be configured to utilize supervised, unsupervised, or reinforcement learning techniques to predict top variations. For example, the top variation machine learning model may utilize supervised machine learning techniques by training on product data and user data as described herein. In some embodiments, the machine learning model may also, or alternately, utilize unsupervised machine learning techniques to predict top variations including, but not limited to, a clustering-based model, a forecasting-based model, a smoothing-based model, or another type of unsupervised machine learning model. In some embodiments, the machine learning model may also, or alternately, utilize reinforcement learning techniques to predict top variations. For example, the model may be trained using the input data and, based on the observed user actions, the model may be rewarded based on its output.

In some embodiments, the product and user data may be analyzed to identify trends and patterns related to top product variations and determine which variations may influence user behavior and interaction, and in some cases, which product variations may be related to an increased likelihood of user behavior such as increasing the likelihood of purchasing an item. In one embodiment, the top variation machine learning model may incorporate a classification function that may be configured to determine which product variations are relevant for a particular objective. The classification function may, for example, continuously learn which product variations are relevant to various potential outcomes. In some embodiments, supervised learning may be incorporated where the machine learning model may classify observations made from various product data and user data. The machine learning model may assign metadata to the observations. The metadata may be updated by the machine learning model to update relevance to the objectives of interest as new observations are made and assign tags to the new observations. The machine learning model may learn which observations are alike and assign metadata to identify these observations. The machine learning model may classify future observations into categories.

In some embodiments, an algorithm, such as a feature subset selection algorithm or an induction algorithm, may be implemented to define groupings or categories. Probabilistic approaches may also be incorporated. One or more estimation methods may be incorporated, such as a parametric classification technique. In various embodiments, the machine learning model may employ a combination of probabilistic and heuristic methods to guide and narrow the data that are analyzed.

In order to provide relevant results that are more likely to indicate outcomes for a particular observed pattern of data, the most relevant patterns may be identified and weighted. In some embodiments a heuristic model can be used to determine product variations that provide an acceptable confidence level in the results. For example, experience-based techniques, such as expert modeling can be used to aid in the initial selection of parameters. The heuristic model can probabilistically indicate parameters of likely impact through, for example, tagging various metadata related to a particular pattern. Feedback from an initial round of analysis can be used to further refine the initial selection, thus implementing a closed loop system that generates likely candidates for product variations in situations where programmatic approaches may be impractical or infeasible. As an example, Markov modeling or variations thereof (e.g., hidden Markov model and hierarchical hidden Markov model) can be used in some embodiments to identify candidate polling frequencies that may otherwise be missed using traditional methods.

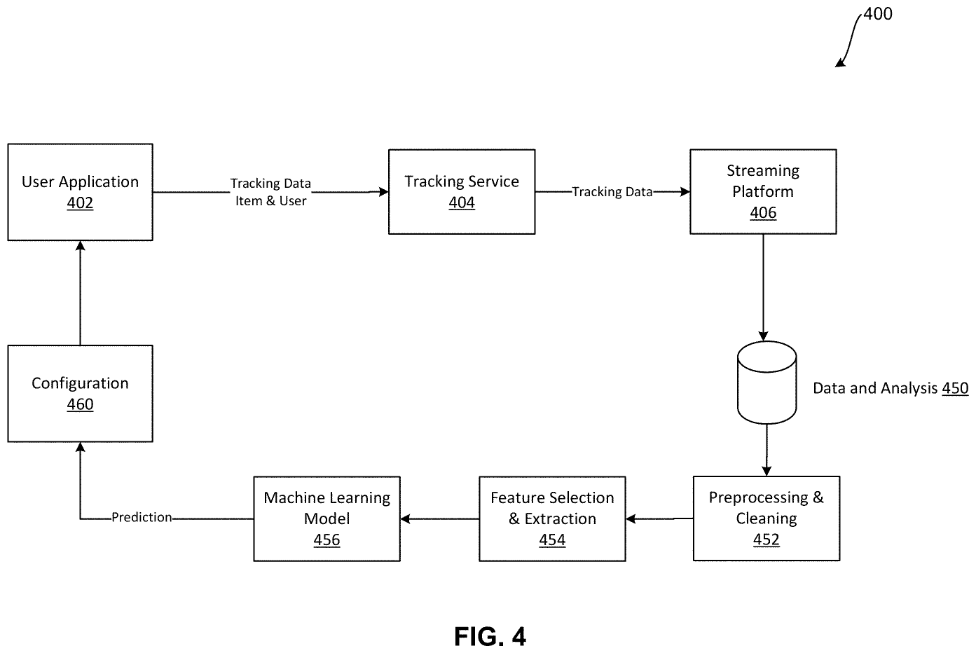

FIG. 4 is a computing system architecture diagram showing an overview of a system disclosed herein for product variations, according to one embodiment. As shown in FIG. 4, a product variation prediction system 400 may be configured to predict product variations based upon product and user data generated by tracking service 404 and received from user application 402.

The tracking service 404 may send selected tracking data to a streaming platform 406. Such a streaming platform may be implemented using a Kafka pipeline, in one implementation. Data streams may be provided to a data storage component and analysis component 450 that may, for example, include Hadoop utilities. The data and analysis component 450 may provide data for a preprocessing and cleaning component 452 that may be configured to process the stored data. The processed data may be provided to a feature selection and extraction component 454 that may be configured to select data and properties for a given item, user, and the like. The processed data may be provided to machine learning model 456 that may use the data and properties to generate a prediction for a product variation and send the prediction to configuration system 460. In some embodiments, the configuration system 460 may be implemented as a distributed key-value database such as Redis.

In some configurations, the machine learning model 456 may be configured to utilize supervised and/or unsupervised machine learning technologies to predict product variations. For example, the machine learning model 456 may utilize supervised machine learning techniques by training on product and user data as described herein. The machine learning model 456 can generate predictions based on features extracted from the product and user information. The predictions can be provided in various forms, such as a single product variation, or a group of top product variations.

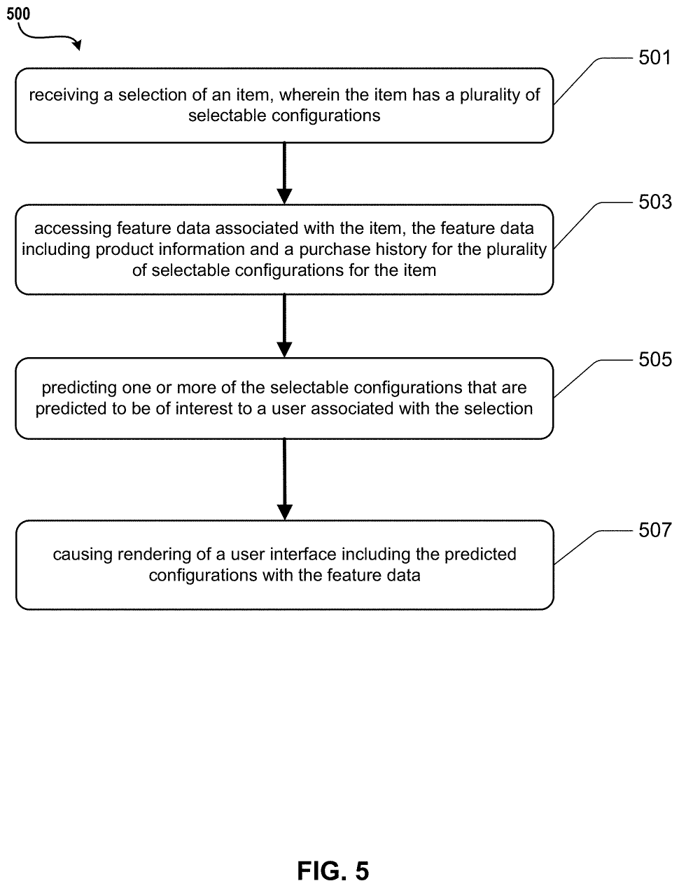

FIG. 5 is a diagram illustrating aspects of a routine 500 for implementing some of the techniques disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

The routine 500 begins at operation 501, which illustrates receiving a selection of an item, wherein the item has a plurality of selectable configurations.

The routine 500 then proceeds to operation 503, which illustrates accessing feature data associated with the item. In an embodiment, the feature data includes product information and a purchase history for the plurality of selectable configurations for the item.

Operation 505 illustrates based on the feature data, predicting one or more of the selectable configurations that are predicted to be of interest to a user associated with the selection.

Next, operation 507 illustrates causing rendering of a user interface including the predicted configurations with the feature data.

In an embodiment, the predicting is performed by a machine learning component.

In an embodiment, the machine learning component utilizes reinforcement learning.

In an embodiment, the product information comprises one or more of a number of sales for each of the selectable configurations, discounts associated with the selectable configurations, and numbers of user clicks for the selectable configurations.

In an embodiment, the user interface a web page.

In an embodiment, the predicting is further based on historical data associated with the user, the historical data comprising previous clicks, add to cart actions, and past purchases.

In an embodiment, each selectable configuration comprises a stock keeping unit (SKU) associated with the item.

In an embodiment, a number of predicted configurations rendered on the user interface is sent based on a rendering capability of display for rendering the information.

In an embodiment, the selectable configurations comprise one or more of color, size, model, or variation.

In an embodiment, the user interface excludes configurations for the item that were not predicted to be of interest to the user.

In an embodiment, a plurality of configurations are presented to the user with the feature data including configurations with selling data and discount data

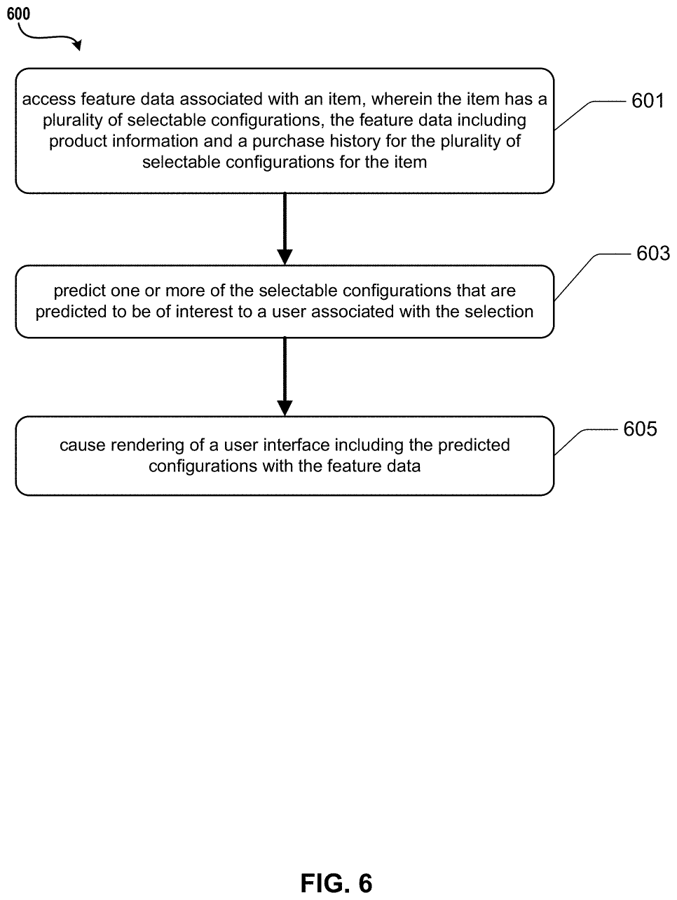

FIG. 6 is a diagram illustrating aspects of a routine 600 for implementing some of the techniques disclosed herein.

The routine 600 begins at operation 601, which illustrates accessing feature data associated with an item. In an embodiment, the item has a plurality of selectable configurations. Additionally and optionally, the feature data includes product information and a purchase history for the plurality of selectable configurations for the item.

The routine 600 then proceeds to operation 603, which illustrates based on the feature data, predicting one or more of the selectable configurations that are predicted to be of interest to a user associated with the selection.

Operation 605 illustrates cause rendering of a user interface including the predicted configurations with the feature data.

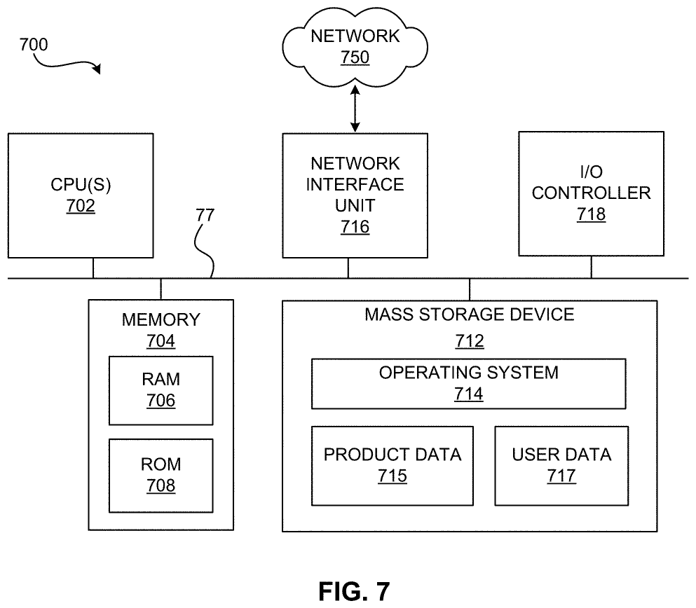

FIG. 7 shows an example computer architecture for a computer capable of providing the functionality described herein such as, for example, a computing device configured to implement the functionality described above with reference to FIGS. 1-6. Thus, the computer architecture 700 illustrated in FIG. 7 illustrates an architecture for a server computer or another type of computing device suitable for implementing the functionality described herein. The computer architecture 700 might be utilized to execute the various software components presented herein to implement the disclosed technologies.

The computer architecture 700 illustrated in FIG. 7 includes a central processing unit 702 (“CPU”), a system memory 704, including a random-access memory 706 (“RAM”) and a read-only memory (“ROM”) 708, and a system bus 77 that couples the memory 704 to the CPU 702. A firmware containing basic routines that help to transfer information between elements within the computer architecture 700, such as during startup, is stored in the ROM 708. The computer architecture 700 further includes a mass storage device 712 for storing an operating system 714, other data, and one or more executable programs, such as storing product data 715 or storing user data 717.

The mass storage device 712 is connected to the CPU 702 through a mass storage controller (not shown) connected to the bus 77. The mass storage device 712 and its associated computer-readable media provide non-volatile storage for the computer architecture 700. Although the description of computer-readable media contained herein refers to a mass storage device, such as a solid-state drive, a hard disk or optical drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

By way of example, and not limitation, computer-readable storage media might include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes of the claims, the phrase “computer storage medium,” “computer-readable storage medium” and variations thereof, does not include waves, signals, and/or other transitory and/or intangible communication media, per se.

According to various implementations, the computer architecture 700 might operate in a networked environment using logical connections to remote computers through a network 750 and/or another network (not shown). A computing device implementing the computer architecture 700 might connect to the network 750 through a network interface unit 716 connected to the bus 77. It should be appreciated that the network interface unit 716 might also be utilized to connect to other types of networks and remote computer systems.

The computer architecture 700 might also include an input/output controller 718 for receiving and processing input from a number of other devices, including a keyboard, mouse, or electronic stylus (not shown in FIG. 7). Similarly, the input/output controller 718 might provide output to a display screen, a printer, or other type of output device (also not shown in FIG. 7).

It should be appreciated that the software components described herein might, when loaded into the CPU 702 and executed, transform the CPU 702 and the overall computer architecture 700 from a general-purpose computing system into a special-purpose computing system customized to facilitate the functionality presented herein. The CPU 702 might be constructed from any number of transistors or other discrete circuit elements, which might individually or collectively assume any number of states. More specifically, the CPU 702 might operate as a finite-state machine, in response to executable instructions contained within the software modules disclosed herein. These computer-executable instructions might transform the CPU 702 by specifying how the CPU 702 transitions between states, thereby transforming the transistors or other discrete hardware elements constituting the CPU 702.

Encoding the software modules presented herein might also transform the physical structure of the computer-readable media presented herein. The specific transformation of physical structure might depend on various factors, in different implementations of this description. Examples of such factors might include, but are not limited to, the technology used to implement the computer-readable media, whether the computer-readable media is characterized as primary or secondary storage, and the like. If the computer-readable media is implemented as semiconductor-based memory, the software disclosed herein might be encoded on the computer-readable media by transforming the physical state of the semiconductor memory. For example, the software might transform the state of transistors, capacitors, or other discrete circuit elements constituting the semiconductor memory. The software might also transform the physical state of such components in order to store data thereupon.

As another example, the computer-readable media disclosed herein might be implemented using magnetic or optical technology. In such implementations, the software presented herein might transform the physical state of magnetic or optical media, when the software is encoded therein. These transformations might include altering the magnetic characteristics of locations within given magnetic media. These transformations might also include altering the physical features or characteristics of locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 might include other types of computing devices, including hand-held computers, embedded computer systems, personal digital assistants, and other types of computing devices known to those skilled in the art.

It is also contemplated that the computer architecture 700 might not include all of the components shown in FIG. 7, might include other components that are not explicitly shown in FIG. 7, or might utilize an architecture completely different than that shown in FIG. 7. For example, and without limitation, the technologies disclosed herein can be utilized with multiple CPUS for improved performance through parallelization, graphics processing units (“GPUs”) for faster computation, and/or tensor processing units (“TPUs”). The term “processor” as used herein encompasses CPUs, GPUs, TPUs, and other types of processors.

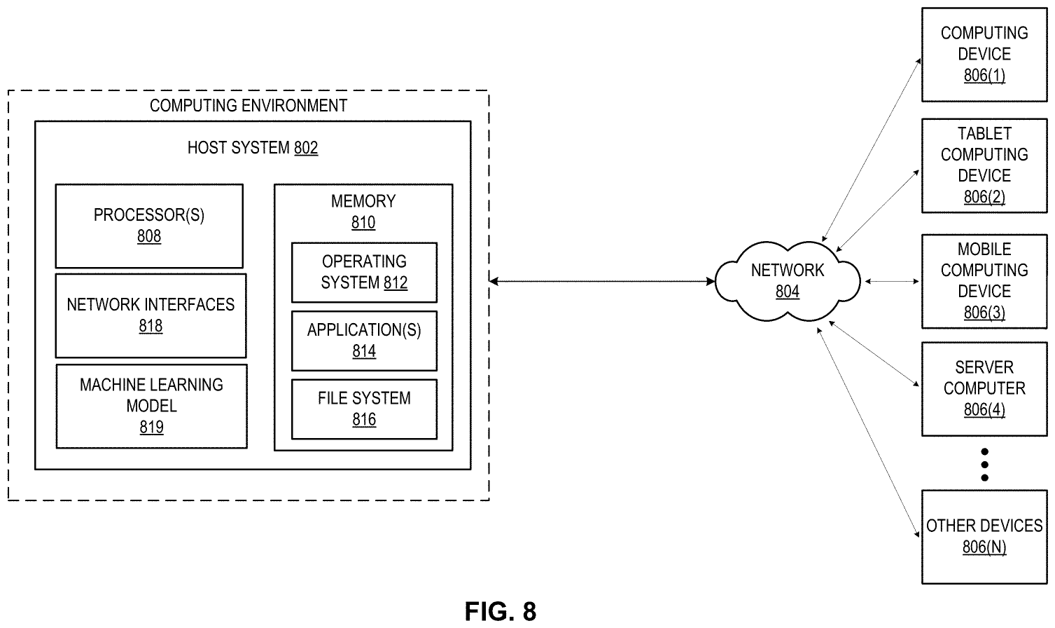

FIG. 8 illustrates an example computing environment capable of executing the techniques and processes described above with respect to FIGS. 1-7. In various examples, the computing environment comprises a host system 802. In various examples, the host system 802 operates on, in communication with, or as part of a network 804.

The network 804 can be or can include various access networks. For example, one or more client devices 806(1) . . . 806(N) can communicate with the host system 802 via the network 804 and/or other connections. The host system 802 and/or client devices can include, but are not limited to, any one of a variety of devices, including portable devices or stationary devices such as a server computer, a smart phone, a mobile phone, a personal digital assistant (PDA), an electronic book device, a laptop computer, a desktop computer, a tablet computer, a portable computer, a gaming console, a personal media player device, or any other electronic device.

According to various implementations, the functionality of the host system 802 can be provided by one or more servers that are executing as part of, or in communication with, the network 804. A server can host various services, virtual machines, portals, and/or other resources. For example, a can host or provide access to one or more portals, Web sites, and/or other information.

The host system 802 can include processor(s) 1208 memory 810. The memory 810 can comprise an operating system 812, application(s) 814, and/or a file system 816. Moreover, the memory 810 can comprise the storage unit(s) 82 described above with respect to FIGS. 1-7.

The processor(s) 808 can be a single processing unit or a number of units, each of which could include multiple different processing units. The processor(s) can include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), other logic circuitry, a system on chip (SoC), and/or any other devices that perform operations based on instructions. Among other capabilities, the processor(s) may be configured to fetch and execute computer-readable instructions stored in the memory 810.

The memory 810 can include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, phase change memory (PCM), static random-access memory (SRAM), dynamic random-access memory (DRAM), other types of random-access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

The host system 802 can communicate over the network 804 via network interfaces 818. The network interfaces 818 can include various types of network hardware and software for supporting communications between two or more devices. The host system 802 may also include machine learning model 819.

The present techniques may involve operations occurring in one or more machines. As used herein, “machine” means physical data-storage and processing hardware programed with instructions to perform specialized computing operations. It is to be understood that two or more different machines may share hardware components. For example, the same integrated circuit may be part of two or more different machines.

It should be understood that the methods described herein can be ended at any time and need not be performed in their entireties. Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As described herein, in conjunction with the FIGURES described herein, the operations of the routines are described herein as being implemented, at least in part, by an application, component, and/or circuit. Although the following illustration refers to the components of specified figures, it can be appreciated that the operations of the routines may be also implemented in many other ways. For example, the routines may be implemented, at least in part, by a computer processor or a processor or processors of another computer. In addition, one or more of the operations of the routines may alternatively or additionally be implemented, at least in part, by a computer working alone or in conjunction with other software modules.

For example, the operations of routines are described herein as being implemented, at least in part, by an application, component and/or circuit, which are generically referred to herein as modules. In some configurations, the modules can be a dynamically linked library (DLL), a statically linked library, functionality produced by an application programing interface (API), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

In closing, although the various technologies presented herein have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method of rendering information, the method comprising:
receiving a selection of an item, wherein the item has a plurality of selectable configurations;
accessing feature data associated with the item, the feature data including product information and a purchase history for the plurality of selectable configurations for the item;
based on the feature data, predicting one or more of the selectable configurations that are predicted to be of interest to a user associated with the selection; and
causing rendering of a user interface including the predicted configurations with the feature data.

2. The method of claim 1, wherein the predicting is performed by a machine learning component.

3. The method of claim 2, wherein the machine learning component utilizes reinforcement learning.

4. The method of claim 1, wherein the product information comprises one or more of a number of sales for each of the selectable configurations, discounts associated with the selectable configurations, and numbers of user clicks for the selectable configurations.

5. The method of claim 1, wherein the user interface is a web page.

6. The method of claim 1, wherein the predicting is further based on historical data associated with the user, the historical data comprising previous clicks, add to cart actions, and past purchases.

7. The method of claim 1, wherein each selectable configuration comprises a stock keeping unit (SKU) associated with the item.

8. The method of claim 1, wherein a number of predicted configurations rendered on the user interface is sent based on a rendering capability of a display for rendering the predicted configurations.

9. The method of claim 1, wherein the selectable configurations comprise one or more of color, size, model, or variation.

10. The method of claim 1, wherein the user interface excludes configurations for the item that were not predicted to be of interest to the user.

11. The method of claim 1, wherein a plurality of configurations are presented to the user with the feature data including configurations with selling data and discount data.

12. A computing system, comprising:
one or more processors; and
a computer-readable storage medium having computer-executable instructions stored thereupon which, when executed by the processor, cause the processor to:
receive a selection of an item, wherein the item has a plurality of selectable configurations;
access feature data associated with the item, the feature data including product information and a purchase history for the plurality of selectable configurations for the item;
based on the feature data, predict one or more of the selectable configurations that are predicted to be of interest to a user associated with the selection; and
cause rendering of a user interface including the predicted configurations.

13. The computing system of claim 12, wherein the predicting is performed by a machine learning component.

14. The computing system of claim 12, wherein the product information comprises one or more of a number of sales for each of the selectable configurations, discounts associated with the selectable configurations, and numbers of user clicks for the selectable configurations.

15. The computing system of claim 12, wherein the predicting is further based on historical data associated with the user, the historical data comprising previous clicks, add to cart actions, and past purchases.

16. The computing system of claim 12, wherein a number of predicted configurations rendered on the user interface is sent based on a rendering capability of display for rendering the information.

17. The computing system of claim 12, wherein the user interface excludes configurations for the item that were not predicted to be of interest to the user.

18. A computer-readable storage medium having computer-executable instructions stored thereupon which, when executed by a processor of a computing device, cause the computing device to:
access feature data associated with an item, wherein the item has a plurality of selectable configurations, the feature data including product information and a purchase history for the plurality of selectable configurations for the item;
based on the feature data, predict one or more of the selectable configurations that are predicted to be of interest to a user associated with a selection of the item; and
cause rendering of a user interface including the predicted configurations with the feature data.

19. The computer-readable storage medium of claim 18, wherein the predicting is performed by a machine learning component trained using reinforcement learning.

20. The computer-readable storage medium of claim 19, wherein the product information comprises one or more of a number of sales for each of the selectable configurations, discounts associated with the selectable configurations, numbers of user clicks for the selectable configurations, and historical data associated with the user, the historical data comprising previous clicks, add to cart actions, and past purchases.
